(19) United States
(12) Patent Application Publication
(10) Pub. No.: US 2004/0114141 A1
(43) Pub. Date: Jun. 17, 2004

(54) Method and system for a media exchange network supporting transparent pc-to-pc media interchange interface

(76) Inventors: Jeyhan Karaoguz, Irvine, CA (US); James Bennett, Laguna Beach, CA (US)

Correspondence Address: MCANDREWS HELD & MALLOY, LTD, 500 WEST MADISON STREET, SUITE 3400, CHICAGO, IL, 60661

(21) Appl. No.: 10/675,287

(22) Filed: Sep. 30, 2003

Related U.S. Application Data
(60) Provisional application No. 60/432,472, filed on Dec. 11, 2002.
(60) Provisional application No. 60/443,894, filed on Jan. 30, 2003.
(60) Provisional application No. 60/457,179, filed on Mar. 25, 2003.
(60) Provisional application No. 60/451,171, filed on Feb. 28, 2003.

(51) Int. Cl. G01N 21/00

(52) U.S. Cl. 356/338

(57) ABSTRACT

Certain aspects of the invention may comprise a method and system for providing media in a communication network in which media stored locally in at least a first location within the communication network may be located and the located media may be organized into channels. The organized channels may contain specific categories of media. Accordingly, at least a portion of the organized channels may be transparently transferred to at least a second location within the communication network. The first and/or second locations may be a home and/or an office. The organized channels may be transparently displayed in at least one constructed display that may be formatted as a graphical user interface. The constructed display may be a media guide, a device guide and/or a channel guide. Notwithstanding, the constructed display may be displayed at the first location such as a home and/or the second location such as a home.

### CROSS-REFERENCE TO RELATED APPLICATIONS/INCORPORATION BY REFERENCE

This application makes reference to, claims priority to, and claims the benefit of: U.S. Provisional Application Serial No. 60/432,472 (Attorney Docket No. 14185US01 01001P-BP-2800) filed Dec. 11, 2002; U.S. Provisional Application Serial No. 60/443,894 (Attorney Docket No. 14274US01 01002P-BP-2801) filed Jan. 30, 2003; U.S. Provisional Application Serial No. 60/457,179 (Attorney Docket No. 14825US01 01015P-BP-2831) filed Mar. 25, 2003; and U.S. Provisional Application Serial No. 60/451,171 (Attorney Docket No. 14794US01 01029P-BP-2826) filed Feb. 28, 2003.

This application also makes reference to: U.S. application Ser. No. ______ (Attorney Docket No. 14185US02 01001P-BP-2800) filed Sep. 8, 2003; and U.S. application Ser. No. ______ (Attorney Docket No. 14274US02 01002P-BP-2801) filed Sep. 11, 2003.

All of the above stated applications are incorporated herein by reference in their entirety.

### FIELD OF THE INVENTION

Certain embodiments of the invention relate to transferring media in a communication network. In particular, certain embodiments of the invention relate to a method and system for a media exchange network supporting transparent pc-to-pc media interchange interface.

### BACKGROUND OF THE INVENTION

The proliferation of digital media devices have resulted in a corresponding increase in the amount of available media types. For example, digital cameras may provide still pictures and in some cases short motion video clips, digital versatile discs (DVDs) and digital camcorders may provide motion video and/or still pictures in some instances, and compact discs (CDs) and MP3 players may provide audio. However, a different software application is required to access and/or deliver the different media types using a personal computer (PC). Additionally, a different software and user interface may be required to manipulate and/or work with each of the different media types. If, for example, it is desirable for a first person to transfer or send pictures from a digital camera to a second person, the first person would have to download the corresponding picture files from the digital camera onto the personal computer. The downloaded picture files may then be attached to an email and the email containing the picture files sent to the second person. Depending on the digital camera and the computer interface, the first person may have to be personal computer savvy in order to download the picture files and attach them to an email since the digital camera and computer interface may be cumbersome and may not be user friendly.

The second person may require a personal computer or a laptop to download the picture files to the personal computer and view the pictures. Again, if the second person is not computer savvy, the second person may require assistance with downloading the picture files to the personal computer or laptop. Depending on the format of the pictures, specialized software may be required to view and manipulate the pictures. Accordingly, depending on the level of personal computer expertise that is possessed by both the second person and the first person, the first person may have to guide the second person through the process of transferring the pictures from the email and viewing the transferred pictures in a compatible software application.

Also, the pictures in the email may be stored in a large file such as an inbox. Accordingly, if the personal computer is upgraded, becomes infected by a virus or the operating system for the personal computer is changed, then the pictures may be lost if they were no previously backed up on a media other than on the personal computer or laptop.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

Certain aspects of the invention may be found in a method and system for providing media in a communication network. Certain embodiments of the method for providing media in a communication network may comprise locating media stored locally in at least a first location in the communication network and organizing the located media into channels. Accordingly, at least a portion of the organized channels may be transparently transferred to at least a second location within the communication network.

The organized channels may be displayed in at least one constructed display such as a media guide, a device guide and/or a channel guide that may be formatted as a graphical user interface. The constructed display may be displayed at the first location and/or the second location. Representations of locally stored media at the second location and representations of the transparently transferred media may be presented in a single constructed display such as the media guide, device guide and/or channel guide. Additionally, representations of broadcast media may also be integrated within the presented single constructed display, where it may coexist with locally stored and transparently transferred media. Accordingly, a channel guide, media guide and/or a device guide, for example, may contain representations of locally stored media, transparently transferred media and/or broadcast media.

In another aspect of the invention, media corresponding to at least a selected portion of the organized channels may also be transparently transferred to at least the second location. An existing constructed display at the second location may also be updated in order to reflect the transparently transferred portion of the selected channels. An authorization may be received from the second location prior to transparently transferring the selected channels and/or media corresponding to the selected channels to at least the second location.

Another embodiment of the invention may provide a machine-readable storage, having stored thereon, a computer program having at least one code section for providing media in a communication network. The at least one code section may be executable by a machine, thereby causing the machine to perform the steps as described above for providing media in a communication network.

Certain embodiments of the system for providing media in a communication network may comprise at least one processor that locates media stored locally in at least a first location in the communication network and organizing the located media into channels. Accordingly, at least a portion of the organized channels may be transparently transferred by the processor to at least a second location within the communication network. The processor may be a media processing system processor, a media management system processor, a computer processor, a media exchange software processor and/or a media peripheral processor.

The processor may cause the organized channels to be displayed in one or more constructed displays such as a media guide, a device guide and/or a channel guide, which may be formatted as a graphical user interface. The constructed display may be displayed at the first location and/or the second location. Representations of locally stored media at the second location and representations of the transparently transferred media may be presented in a single constructed display such as the media guide, device guide and/or channel guide. Additionally, representations of broadcast media may also be integrated by the processor within the presented single constructed display, where it may coexist with locally stored and transparently transferred media. In this regard, the updated constructed display such as a channel guide, media guide and/or a device guide may contain representations of media for the transferred channels, local media and/or broadcast media.

In another aspect of the invention, media corresponding to at least a selected portion of the selected channels may also be transparently transferred by the processor to the at least the second location. The processor may update the existing constructed display situated at the second location in order to reflect the transparently transferred portion of the selected channels. An authorization may be received by the processor from the second location prior to transparently transferring the selected channels to at least the second location.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram of a communication network for exchanging media or a media exchange network that may be utilized in connection with supporting a transparent personal computer to personal computer (pc-to-pc) media interchange interface in accordance with an embodiment of the present invention.

FIG. 2 is a diagram illustrating several sources of media program content that may be available to the transparent personal computer to personal computer (pc-to-pc) media interchange interface of FIG. 1, in accordance with an embodiment of the present invention.

FIG. 3 is a schematic block diagram of a first exemplary media exchange network in accordance with an embodiment of the present invention.

FIG. 4 is a schematic block diagram of performing personal media exchange over a second exemplary media exchange network in accordance with an embodiment of the present invention.

FIG. 5 is a schematic block diagram of performing third-party media exchange over a third exemplary media exchange network in accordance with an embodiment of the present invention.

FIG. 6 is an exemplary illustration of a TV guide channel user interface in accordance with an embodiment of the present invention.

FIG. 7 is an exemplary illustration of several instantiations of a TV guide channel user interface of FIG. 4 in accordance with an embodiment of the present invention.

FIG. 8 is an exemplary illustration of a TV guide channel user interface showing several options of a pushed media in accordance with an embodiment of the present invention.

FIG. 9A is a schematic block diagram of a media processing system (MPS) interfacing to media capture peripherals in accordance with an embodiment of the present invention.

FIG. 9B illustrates an alternative embodiment of a media processing system (MPS) in accordance with various aspects of the present invention.

FIG. 10 is a schematic block diagram of a PC and an MPS interfacing to a server on a media exchange network in accordance with an embodiment of the present invention.

FIG. 11 is a schematic block diagram of a PC interfacing to personal media capture devices and remote media storage on a media exchange network in accordance with an embodiment of the present invention.

### DETAILED DESCRIPTION OF THE INVENTION

Certain aspects of the invention may be found in a method and system for providing media in a communication network. Certain embodiments of the method for providing media in a communication network may comprise locating media stored locally at least at a first location in the communication network and organizing the located media into channels. Accordingly, at least a portion of the organized channels may be transparently transferred to at least a second location within the communication network.

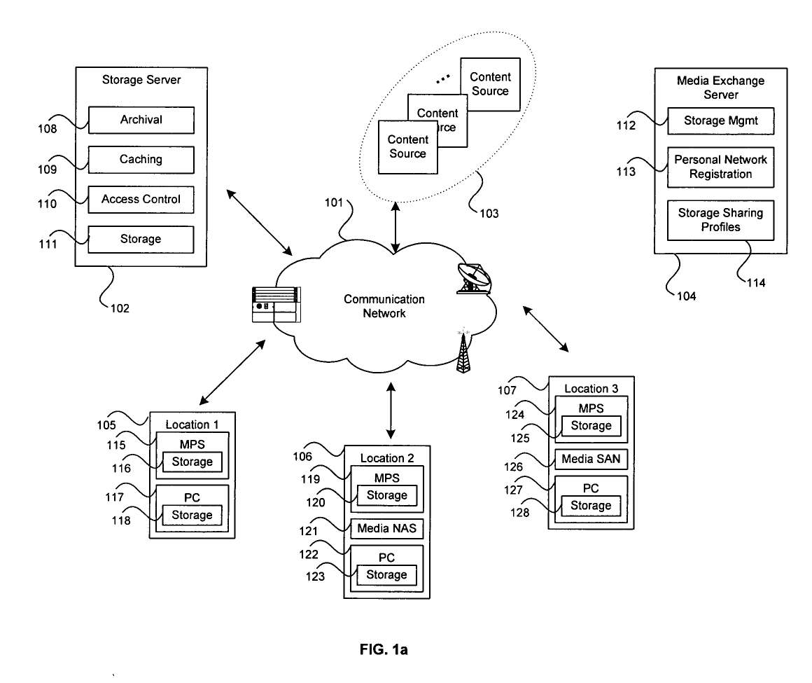

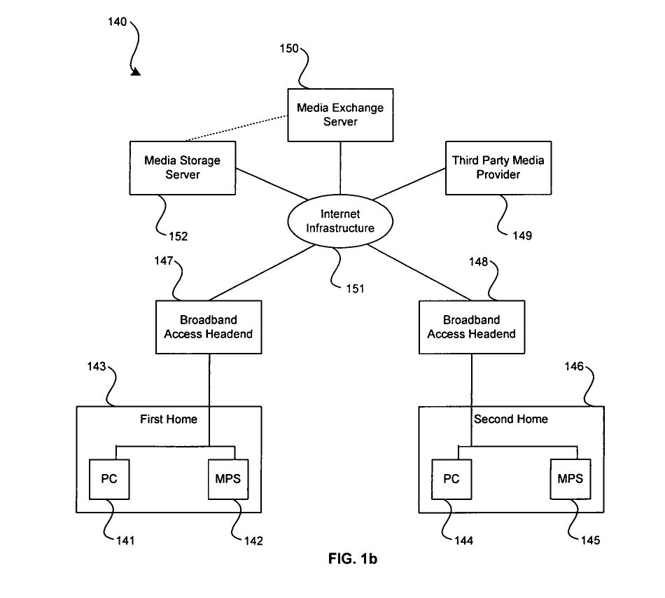

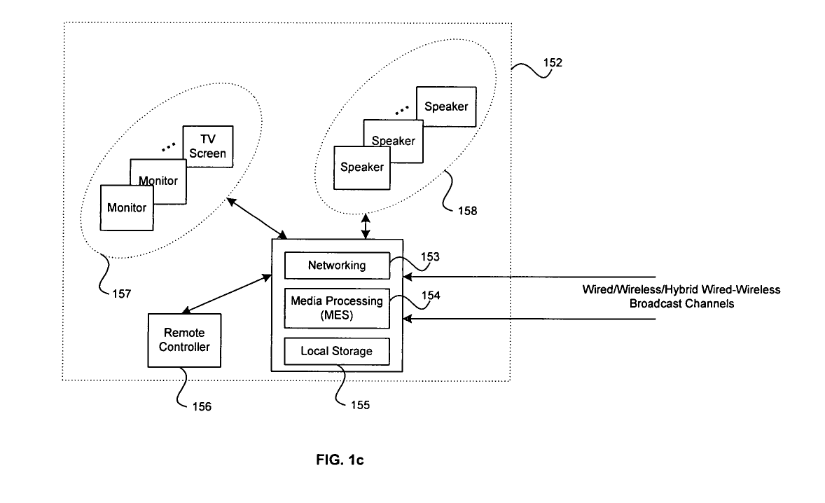

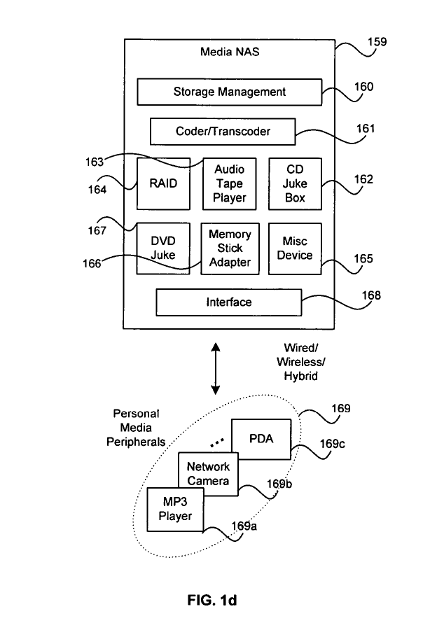

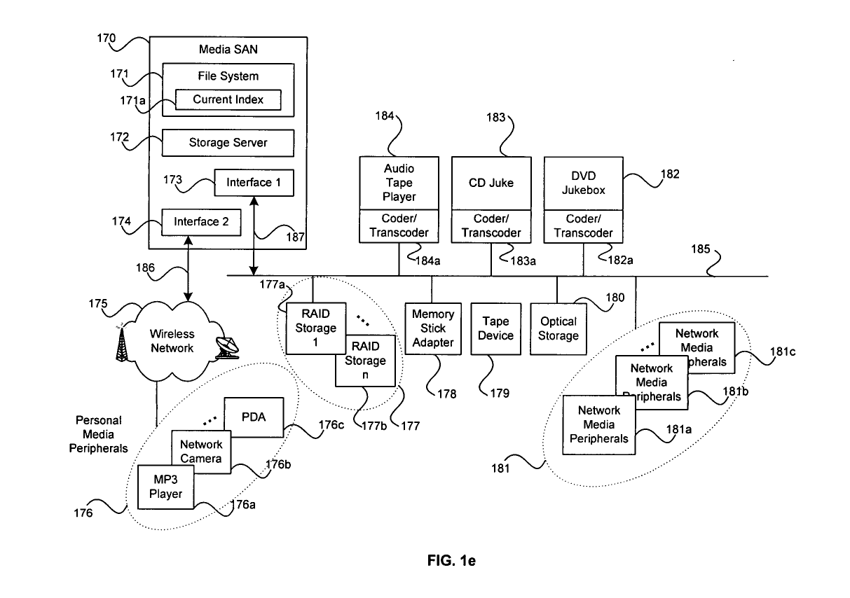

FIG. 1 is a block diagram of a communication network for exchanging media or a media exchange network 100 that may be utilized in connection with supporting a transparent personal computer to personal computer (pc-to-pc) media interchange interface in accordance with an embodiment of the present invention. Referring to FIG. 1, the media exchange network (MEN) of FIG. 1 may comprise a first personal computer 101, which may be situated at a first location such as a user's home 103. The media exchange network 100 may also include a communication infrastructure 104, external processing hardware support 105 and remote media storage 106. A second personal computer 107 may be situated at a second location, which may be a remote location 108 such as an office. A third location such as a Parent's home 110 may include a personal computer 109. The media exchange network 100 may be a secure, closed network environment that may only be accessible to pre-defined users or subscribers and/or service providers. Notwithstanding, the invention may not be limited in this regard, and at least a portion of the network and/or services provided by the network may be publicly accessible. In this regard, the public accessibility may be for a limited time or duration. In any case, the media exchange network 100 may be a communication network that may be adapted to facilitate communication or transfer of media between networking components or entities within the media exchange network 100.

The personal computers in the media exchange network 100 may each include media exchange software and a networking component. In this regard, the personal computer 101 may include media exchange software platform 111 and networking component 112. The personal computer 107 may also include media exchange software 111 and networking component 112 and the personal computer 109 may include media exchange software platform 111 and networking component 112. The networking components 112 of personal computers 101, 107 and 109 may be configured to provide networking connectivity to the communication infrastructure 104.

The media exchange software platform 111 may provide functions and capabilities, which may include, but are not limited to media “push” or otherwise transfer of media capability, media “access” capability, media channel construction/selection, image sequence selection, text and voice overlay, channel and program naming and inter-home routing selection. The media exchange software platform 111 may also provide authorship and media rights management, shared inter-home or inter-location media experience, billing services, and integrated television channel guide look-and-feel functionalities.

The external processing hardware support 105 may include at least one server such as a centralized Internet server, a media exchange server, a peer-to-peer server, or a cable headend. Notwithstanding, functions provided by the server may alternatively be distributed over various hosts systems/computers and/or remote personal computers. The media exchange software platform 111 may also reside on the external processing hardware support server 105. The remote media storage 106 may include user media storage and distribution systems 113 and/or third party media storage and distribution systems 114. Although not shown, a personal computer may be adapted to function as a media processing system comprising suitable hardware and software that may be configured to process and communicate or transfer media.

The communication infrastructure 104 may include at least one of Internet infrastructure, satellite infrastructure, cable infrastructure, dial-up infrastructure, cellular infrastructure, xDSL infrastructure, optical infrastructure, or some other access and/or transport infrastructure. The communication infrastructure 104 may provide a common access and/or transport communication path for the first location or user's home 103, the second location or remote office location 108, the third location or parent's home 110 and the remote media storage 106. In this regard, the communication infrastructure 104 may provide access and/or a transport communication path that may link users and service providers of the media exchange network 100.

The communication network 100 or media exchange network 100 may provide various networking functions or media exchange management functions 114 such as generating personal network associations, personal storage management, media capture device support, security/authentication/authorization support, authorship tracking and billing and address registration and maintenance. These media exchange management functions 114 may be distributed throughout various parts of the media exchange network 100. For example, the personal network associations and personal storage management functions may be integrated into the personal computer 101 at the user's home 102.

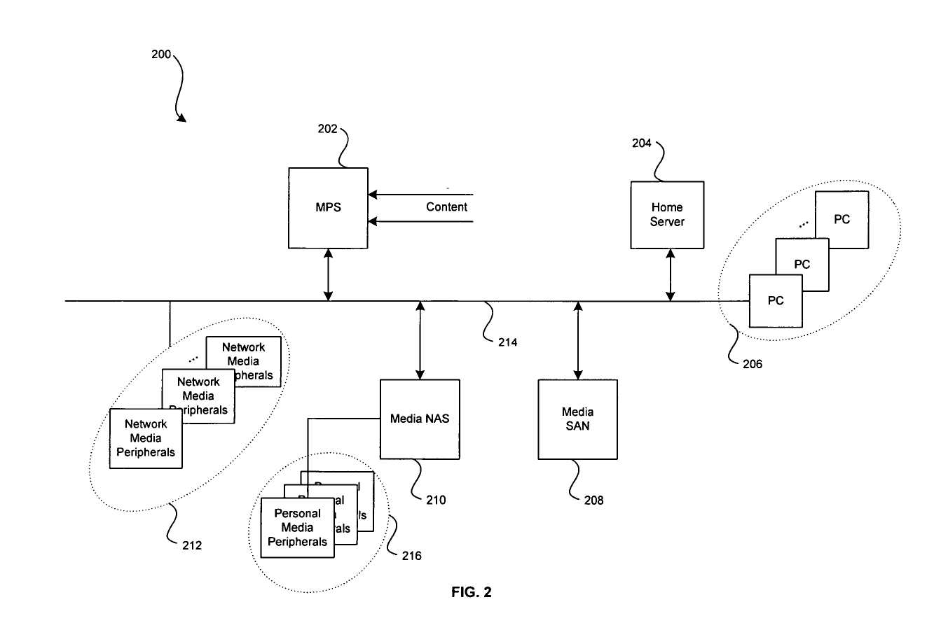

FIG. 2 is a diagram illustrating several sources of media program content that may be available to the transparent personal computer to personal computer (pc-to-pc) media interchange interface of FIG. 1, in accordance with an embodiment of the present invention. The personal computer environment 210 may be part of a media exchange network that may be utilized to exchange media content between different users on the media exchange network 100 of FIG. 1.

The personal computer environment 210 may comprise a media exchange software (MES) platform 211. The media exchange software platform 211 may provide a channel guide interface 212, a device view or device guide 213, and/or a media view or media guide 214. The media exchange software platform may also provide the functionality to store a mixture of commercial broadcast programs and personal media programs into channels of the media guide interface. Accordingly, data representative of local media, personal media programs and/or commercial broadcast programs may be presented in the channel guide 212, media guide 214 and/or device guide 213. A user of a media processing system and/or a personal computer may then select one of the local media, personal media programs and commercial broadcast media programs for playback and/or viewing.

The device view or device guide 213 may comprise a table of devices on the media exchange network versus media content categories. For example, the device guide 213 may comprise a third (3^{rd}) party server, the device guide storing, for example, representations of digital movies arranged in one or more media content categories. The media view or guide 214 may comprise a table of media content categories on the media exchange network versus specific media content. An exemplary media view may comprise a “Music” media content category, storing representations of songs from several compact discs as MP3 files or the specific media content. A channel view or channel guide 212 of a personal computer may comprise a table of media channels along with corresponding scheduled media content, in accordance with an embodiment of the present invention. A media view and/or media guide 214 of a personal computer may comprise a table of media content categories versus media content, in accordance with an embodiment of the invention. Both the channel view and/or guide 212, and the media view or guide 214 may be viewed by a user on a television screen of a media processing system or on a display of a personal computer.

U.S. patent application Ser. No. ______ (Attorney Docket No. 14276US02) filed Sep. 30, 2003 and U.S. patent application Ser. No. ______ (Attorney Docket No. 14278US02) filed Sep. 30, 2003 provides exemplary media view or guide, device view or guide, and channel view or guide, and are hereby incorporated herein by reference in their entirety.

In accordance with an embodiment of the present invention, representations of the media content may be moved from the device view 213 and/or the media view 214 into various slots of the media guide interface 212 which may represent the channels. The moved media content may comprise both third (3^{rd}) party commercial broadcast program content and/or personal media content.

A personal computer may be utilized, instead of a media processing system, to interface to the media exchange network for the purpose of providing a media guide interface. Also, a set-top-box may be used with the communication network for exchanging media to provide a media guide interface that may be displayed on a television screen and manipulated with a remote control or other pointing or navigation device.

Current set-top-boxes may be software enhanced to create a media processing system that provides full media exchange network interfacing and functionality via a television screen with a media guide interface having a television channel guide look-and-feel. Personal computers may be software enhanced as well and provide the same media guide interface with a television channel guide look-and-feel. Therefore, the media exchange network supports both personal computers and media processing systems in a similar manner. Alternatively, a fully integrated media processing system may be designed from the ground up, having full media processing system capability, without upgrading an existing system. Additionally, current set-top-boxes may also be hardware enhanced to create a media processing system that provides full media exchange network interfacing and functionality via a television screen with a media guide interface having a television channel guide look-and-feel. Personal computers may also be hardware enhanced in order to provide a similar media guide interface with a television channel guide look-and-feel. Hardware enhancement may include, for example, adding plug-in cards to the set-top-boxes and/or personal computers.

In the case of a media processing system or enhanced set-top-box configuration, a user may utilize, for example, a remote control to control the media guide interface that may be displayed on a television screen. In the case of a personal computer configuration, a user may utilize, for example, a keyboard, mouse or other computer peripheral to control the media guide interface that may be display on a computer monitor.

A media processing system may also comprise a set-top-box (STB), a PC, and/or a television with a media management system (MMS). A media management system may also be referred to as a media exchange software (MES) platform. Notwithstanding, a media management system may include a software platform operating on at least one processor that may provide certain functionality including user interface functionality, distributed storage functionality, networking functionality, and automatic control and monitoring of media peripheral devices. For example, a media management system may provide automatic control of media peripheral devices, automatic status monitoring of media peripheral devices, and inter-home media processing system routing selection. A media processing system may also be referred to as a media-box and/or an M-box. Any personal computer may indirectly access and/or control any media peripheral device in instances where the personal computer may include a media management system. Such access and/or control may be accomplished through various communication pathways via the media processing system or outside of the media processing system. A media processing system may also have the capability to automatically access and control any media peripheral device without user interaction and/or with user intervention. A personal computer (PC) may include media exchange software running on or being executed by the personal computer and may be referred to as a media processing system. The media processing system may also include a speech recognition engine that may be adapted to receive input speech and utilize the input speech control various functions of the media processing system.

Each of the elements or components of the network for communicating media or media exchange network may be identified by a network protocol address or other identifier which may include, but is not limited to, an Internet protocol (IP) address, a media access control (MAC) address and an electronic serial number (ESN). Examples of elements or components that may be identified by such addresses or identifiers may include media processing systems, media management systems, personal computers, media or content providers, media exchange software platforms and media peripherals.

In accordance with an embodiment of the invention, with reference to FIG. 1 and FIG. 2, media stored locally in at least a first location 103 within the communication network 100 may be located and the located media may be organized into channels. For example, the channels may contain specific categories of media. Accordingly, at least a portion of the organized channels may be transparently transferred to at least a second location 110 within the communication network 100. The first and/or second locations 103, 110 may be a home and/or an office. The organized channels may be displayed in at least one constructed display that may be formatted as a graphical user interface. In this regard, the constructed display may be a media guide, a device guide and/or a channel guide. Notwithstanding, the constructed display may be displayed at the first location such as a home and/or the second location such as a home.

Representations of the locally stored media at the second location 110 and representations of the transparently transferred media may be presented in a single constructed display such as the media guide, device guide and/or channel guide. Additionally, representations of broadcast media may also be integrated within the presented single constructed display, where it may coexist with locally stored and transparently transferred media. Accordingly, the media guide, device guide and/or channel guide at the second location 110 may contain representations of the local media, transferred media and/or broadcast media. The broadcast media may be distributed from a broadcast television station and/or from a cable provider, for example.

In another aspect of the invention, media corresponding to at least a selected portion of the organized channels may also be transparently transferred to at least the second location 110 from the first location 103. An existing constructed display at the second location 110 may also be updated to reflect the transparently transferred portion of the selected channels. An authorization may be received from the second location 110 prior to transparently transferring the selected channels to at least the second location 110. In this manner, media may be transferred from the first location 103 to the second location 110 when authorized. A profile, user setting or other type of user authorization may be utilized to facilitate transparent transfer of media from the first location 103 to the second location 110.

Another embodiment of the invention may include a system for providing media in a communication network. With reference to FIG. 1 and FIG. 2, the system may comprise at least one processor that locates media stored locally at least at a first location 103, such as a home or office, in the communication network and organizing the located media into channels. Accordingly, at least a portion of the organized channels may be transparently transferred by the processor to at least a second location 110 within the communication network 100. The second location 110 may also be a home or office. The processor may be a media processing system processor, a media management system processor, a computer processor, a media exchange software processor and a media peripheral processor.

The processor may be configured to cause the organized channels to be displayed in one or more constructed displays such as a media guide 214, a device guide 213 and/or a channel guide 212, which may be formatted as a graphical user interface. The constructed display may be displayed at the first location 103 and/or the second location 110. Representations of locally stored media at the second location 110 and representations of the transparently transferred media may be presented in a single constructed display such as the media guide 214, device guide 213 and/or channel guide 211. Additionally, representations of broadcast media may also be integrated by the processor within the presented single constructed display, where it may coexist with locally stored and transparently transferred media. In this regard, the constructed display such as the channel guide may contain representations of local media, transparently transferred media and broadcast media.

In another aspect of the invention, media corresponding to at least a selected portion of the organized channels may also be transparently transferred by the processor to the at least the second location 110. The processor may update the existing constructed display at the second location 110 in order to reflect the transparently transferred portion of the selected channels. An authorization may be received by the processor from the second location 110 prior to the processor transparent transferring the selected channels to at least the second location 110.

A major challenge is to be able to transfer and share many different types of digital media, data, and services between one device/location and another with ease while being able to index, manage, and store the digital media and data.

For example, it is desirable to be able to distribute and store many types of digital media in a PC and/or television environment in a user-friendly manner without requiring many different types of software applications and/or unique and dedicated interfaces. Any networking issues or other technical issues should be transparent to the users. It is also desirable to take advantage of existing hardware infrastructure, as much as possible, when providing such capability.

In an embodiment of the present invention, a media exchange network is provided that enables many types of digital media, data, and/or services to be stored, indexed, viewed, searched for, pushed from one user to another, and requested by users, using a media guide user interface. The media exchange network also allows a user to construct personal media channels that comprise his personal digital media (e.g., captured digital pictures, digital video, digital audio, etc.), request that third-party media channels be constructed from third-party digital media, and access the media channels pushed to him by other users on the media exchange network.

PC's may be used but are not required to interface to the media exchange network for the purpose of exchanging digital media, data, and services. Instead, set-top-boxes or integrated MPS's (media processing systems) may be used with the media exchange network to perform all of the previously described media exchange functions using a remote control with a television screen.

Current set-top-boxes may be software enhanced to create a MPS that provides full media exchange network interfacing and functionality via a TV screen with a TV guide look-and-feel. PC's may be software enhanced as well and provide the same TV guide look-and-feel. Therefore, the media exchange network supports both PC's and MPS's in a similar manner. Alternatively, a fully integrated MPS may be designed from the ground up, having full MPS capability.

In the case of an MPS configuration, the user takes advantage of his remote control and TV screen to use the media exchange network. In the case of a PC configuration, the user takes advantage of his keyboard and/or mouse to use the media exchange network.

An MPS or enhanced PC is effectively a storage and distribution platform for the exchange of personal and third party digital media, data, and services as well as for bringing the conventional television channels to a user's home. An MPS and/or PC connects to the media exchange network via an existing communication infrastructure which may include cable, DSL, satellite, etc. The connection to the communication infrastructure may be hard-wired or wireless.

The media exchange network allows users to effectively become their own broadcasters from their own homes by creating their own media channels and pushing those media channels to other authorized users on the media exchange network, such as friends and family members.

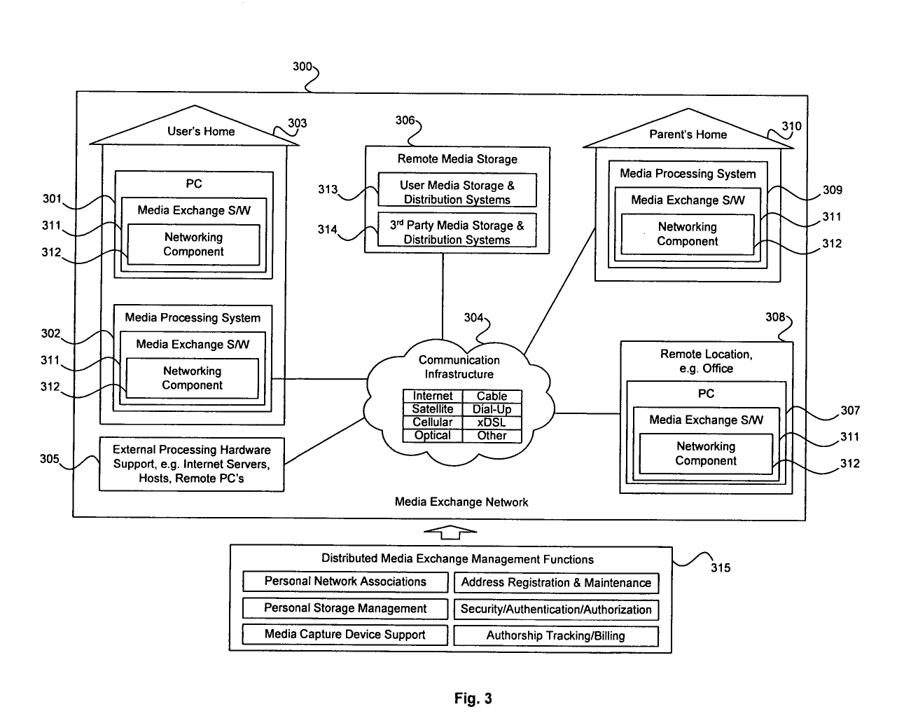

FIG. 3 comprises a media exchange network 300 for exchanging and sharing digital media, data, and services in accordance with an embodiment of the present invention. The media exchange network 300 is a secure, closed network environment that is only accessible to pre-defined users and service providers. The media exchange network of FIG. 3 comprises a first PC 301 and a first media processing system (MPS) 302 at a user's home 303, a communication infrastructure 304, external processing hardware support 305, remote media storage 306, a second PC 307 at a remote location 308 such as an office, and a second MPS 309 at a parent's home 310.

The PC's 301 and 307 and the MPS's 302 and 309 each include a media exchange software (MES) platform 311 and a networking component 312 for connectivity. The MES platform 311 provides multiple capabilities including media “push” capability, media “access” capability, media channel construction/selection, image sequence selection, text and voice overlay, channel and program naming, inter-home routing selection, authorship and media rights management, shared inter-home media experience, billing service, and an integrated media guide interface providing a TV channel guide look-and-feel.

The external processing hardware support 305 comprises at least one server such as a centralized internet server, a peer-to-peer server, or cable head end. The server may alternatively be distributed over various hosts or remote PC's. The MES platform 311 may also reside on the external processing hardware support server 305. The remote media storage 306 may comprise user media storage and distribution systems 313 and/or third party media storage and distribution systems 314.

The communication infrastructure 304 may comprise at least one of internet infrastructure, satellite infrastructure, cable infrastructure, dial-up infrastructure, cellular infrastructure, xDSL infrastructure, optical infrastructure, or some other infrastructure. The communication infrastructure 304 links the user's home 303, parent's home 310, remote media storage 306, and remote location office 308 to each other (i.e., the communication infrastructure 304 links all users and service providers of the media exchange network 300).

The various functions 315 of the media exchange network 300 comprise generating personal network associations, personal storage management, media capture device support, security/authentication/authorization support, authorship tracking and billing and address registration and maintenance. These media exchange management functions 315 may be distributed over various parts of the media exchange network 300. For example, the personal network associations and personal storage management functions may be integrated in the PC 301 at the user's home 303.

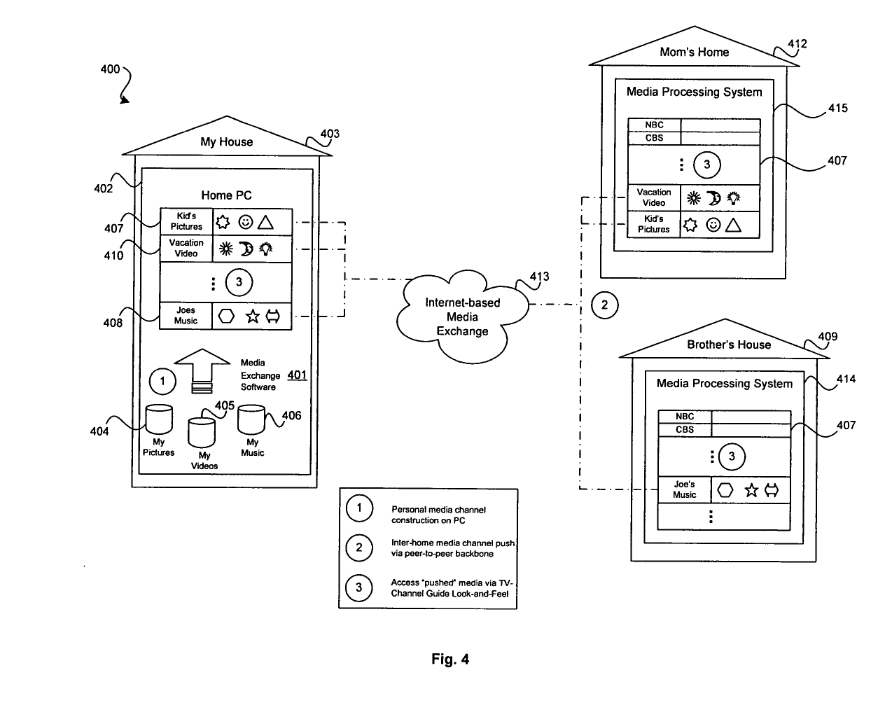

FIG. 4 illustrates an example of personal media exchange over a media exchange network 400 in accordance with an embodiment of the present invention. FIG. 4 is also an exemplary system that may be utilized in connection with supporting a transparent pc-to-pc media interchange interface in accordance with an embodiment of the invention. Referring to FIG. 4, there is shown a media exchange network 400 comprising a personal computer 402 located at “My House” 403, a media processing system 414 located at “Brother's House” 409, and a media processing system 415 located at “Mom's House” 412.

The personal computer 402 may comprise a media exchange software (MES) platform 401 and a personal computer storage. The media exchange software platform 401 may be adapted to provide a channel view or channel guide user interface 407, which may be utilized to display transparently transferred media. The personal computer storage may comprise, for example, folders “My pictures” 404, “My Videos” 405, and “My Music” 406. The “My pictures” folder 404 may be adapted to store images, the “My Videos” folder 405 may be adapted to store videos and the “My Music” folder 406 may be adapted to store music file such as WAV, MP3, and/or WMA formatted audio.

The media processing systems 414 and 415 at “Brother's House” 409 and “Mom's House” 412, respectively, may also comprise a media exchange software platform (not shown) and personal computer storage (not shown) similar to that of the personal computer 402. The media exchange software platforms in media processing systems 414 and 415 may be adapted to provide channel view or channel guide user interfaces 404 similar to the channel view or channel guide user interface 407 of the personal computer 411. Accordingly, the media processing systems 414, 415 may be adapted to provide a channel guide, media guide and/or a device guide displaying representations of transparently transferred media, local media and/or broadcast media.

An Internet-based media exchange network infrastructure 413 may provide connectivity for the personal computer 402, the media processing systems 414 and the media processing 415 located at “Brother's House.” Accordingly, the Internet-based media exchange network infrastructure 413 may be adapted to facilitate exchange of media among the media processing systems 414, 415 and the personal computer 402. In this regard, the Internet-based media exchange network infrastructure 413 may facilitate the transparent transfer of media from a first location such as the “Brother's House” 409 to a second location such as the “Mom's House” 412. Mom may authorize brother to transparently transfer media to “Mom's House” 412 from “Brother's House”409.

Referring to FIG. 4, in step 1, the media exchange software (MES) platform 401 may be utilized to construct personal media channels on the personal computer 402 by a user at “my house” 403. The constructed media channels may be generated from locally stored media in accordance with an aspect of the invention. For example, with various media stored on the PC 402 such as digital pictures 404, videos 405, and music 406, the MES platform 401 may allow the digital media to be organized by a user into several channels having a media guide user interface 407. The media guide user interface containing representations of media stored in “My Pictures” 404, “My Videos” 405 and “My Music” 406, may be displayed on a monitor coupled to the personal computer 402. The location “Brother's house” 409 may include a first media processing system 414 and the location “Mom's house” 412 may include a second media processing system 415 connected to the media exchange network 400 of FIG. 4. The media processing systems 414 and 415 my also be configured to provide a media guide user interface 407.

In step 2, the user located at “my house” 403 may push or otherwise cause a media channel 408 such as “Joe's Music” to be communicated to “brother's house” 409. Additionally, two media channels 410 and 411 such as “Vacation Video” and “Kid's Pictures” may be pushed or otherwise communicated to “Mom's house” 412 via a peer-to-peer server 413 over the Internet-based media exchange network 400. More specifically, the constructed media channel may be transparently transferred from the location “my house” 403 to the “Brother's house” 409. The first media processing system 414 connected to the media exchange network 400 at the location “Brother's house” 409 may include display representations of the transferred media that may be presented in a channel guide displayed at the “Brother's house” 409.

In step 3, brother located at “Brothers House” and/or Mom located at “Mom's House” may access the pushed or otherwise transparently transferred media channels via their respective media processing systems 414 and 415. Accordingly, utilizing a media or channel guide displayed on a television screen of their respective media processing system's television, Mom and/or Brother may utilize a remote control to select and playback contents of the transparently transferred media channels.

Representations of the transferred media channels may be combined and viewed in a single media guide or device guide, for example, along with local media and broadcast channel media. Accordingly, using the single media guide or device guide, Mom or brother may select any of local media, transparently transferred media and broadcast media to be displayed on a television screen of their respective media processing system's television.

FIG. 5 illustrates an example of third-party media exchange over a media exchange network 500 in accordance with an embodiment of the present invention. In step 1, a PC-initiated third-party request is made by a first party 501 via an internet-based media exchange network 500 using a media guide user interface 502 on a PC 503. In step 2, an anonymous delivery of the requested third-party channel 504 is made to a second party 505 via the internet-based media exchange network 500. In step 3, the second party 505 accesses the third-party channel 504 using a media guide user interface 506 on a TV screen 507 that is integrated into an MPS 508.

Similarly, in step A, an MPS-initiated third-party request is made by a second party 505 via an internet-based media exchange network 500 using a media guide user interface 506 on a TV screen 507 using a remote control 509. The second party 505 may key in a code, using his remote control 509, that is correlated to a commercial or some other third party broadcast media. In step B, an anonymous delivery of the requested third-party channel 504 is made to a first party 501 via the internet-based media exchange network 500. In step C, the first party 501 accesses the third-party channel 504 using a media guide user interface 502 on a PC 503.

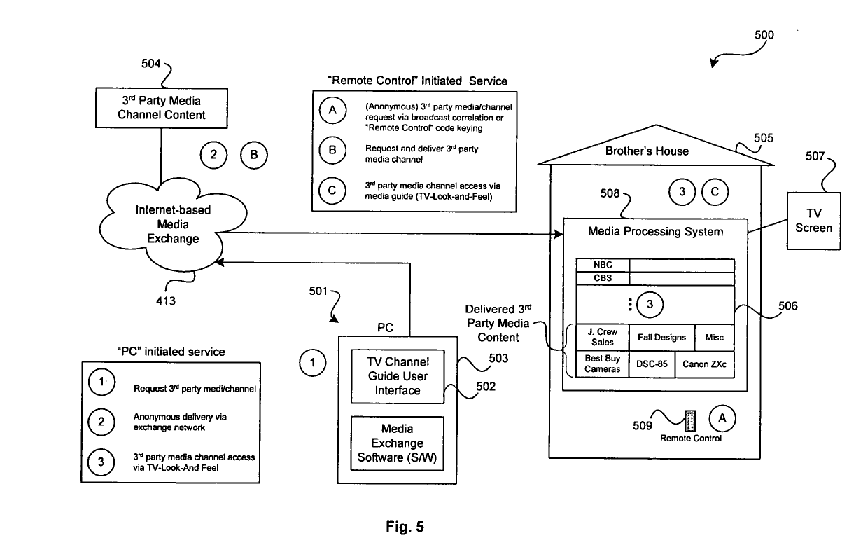

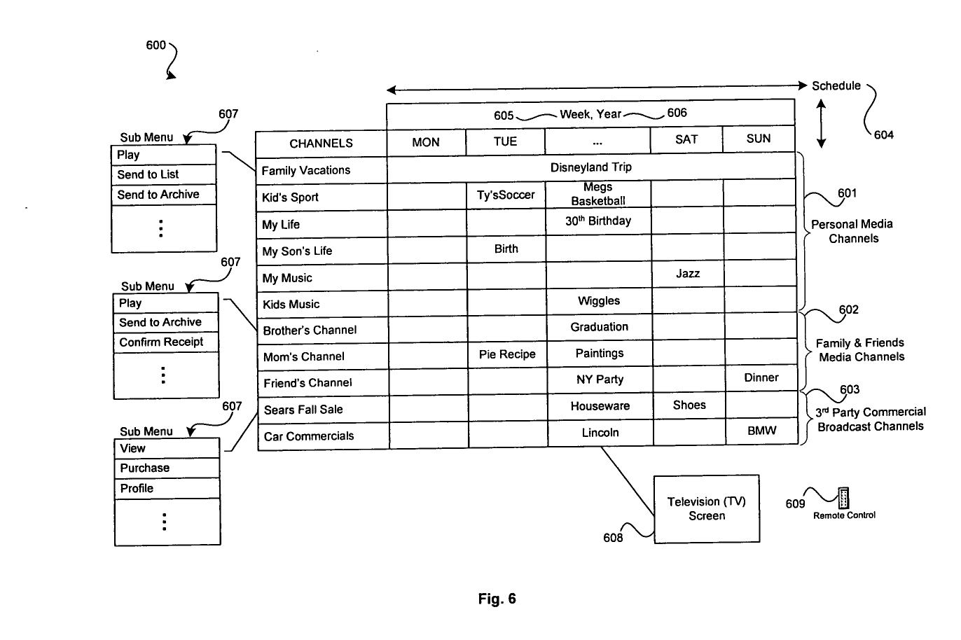

FIG. 6 illustrates a media guide user interface 600 in accordance with an embodiment of the present invention. The media guide user interface 600 may be displayed on a TV screen 608 and controlled by a remote control device 609. Also, the media guide user interface 600 may be displayed on a PC monitor and controlled by a keyboard or mouse.

The media guide user interface 600 may be configured not only for conventional TV channels but also for personal media channels 601 that are constructed by a user of a media exchange network, friend's and family's media channels 602 constructed by friends and family, and third party channels 603 that are constructed by third parties either upon request by a user of a media exchange network or based on a profile of a user.

The personal media channels 601 may include, for example, a “family vacations channel”, a “kid's sports channel”, a “my life channel”, a “son's life channel”, a “my music channel”, and a “kid's music channel”. The friends and family media channels 602 may include, for example, a “brother's channel”, a “Mom's channel”, and a “friend's channel”. The third party media channels 603 may include, for example, a “Sears Fall sale channel” and a “car commercials channel”.

Each media channel may correspond to a schedule 604 showing, for example, a week 605 and a year 606. For example, under the “kid's sports channel”, Ty's soccer game could be scheduled to be viewed on Tuesday of the current week 605 and current year 606. For each media channel, a sub-menu 607 allows for selection of certain control and access functions such as “play”, “send to list”, “send to archive”, “confirm receipt”, “view”, “purchase”, and “profile”.

FIG. 7 illustrates possible multiple instantiations of a media guide user interface 700 in accordance with an embodiment of the present invention. The media guide user interface 700 may be viewed with a schedule having formats of, for example, “month, year”, “week#, year”, “day, week#”, or “hour, day”.

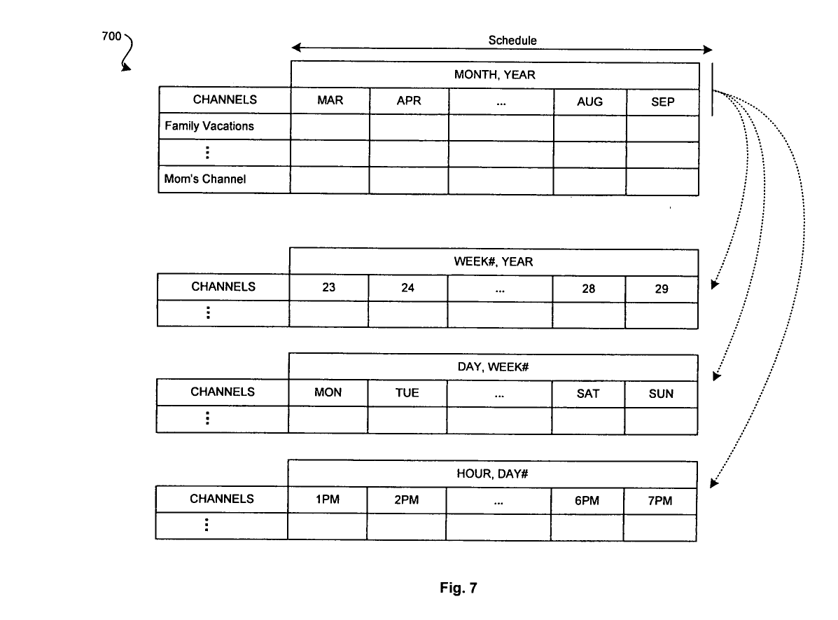

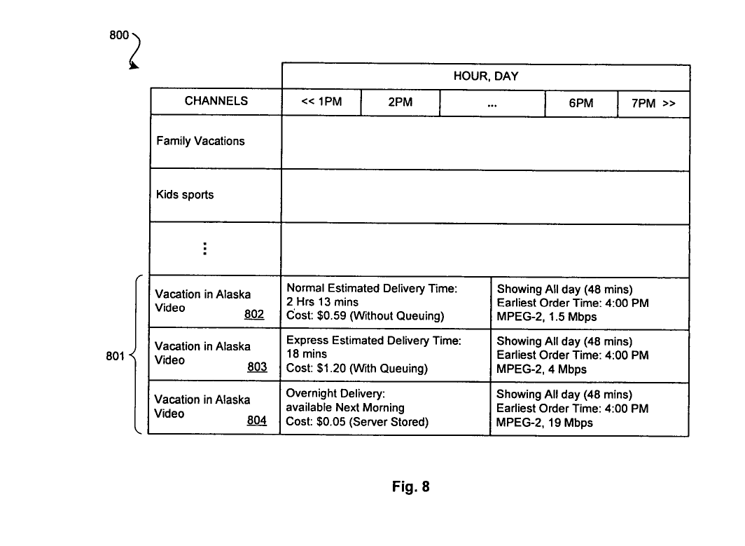

Referring to FIG. 8, a user of a media exchange network may push a media channel (e.g., “Vacation in Alaska Video”) to a friend who is on the same media exchange network. The media guide user interface 800 may give the friend several options 801 for how to accept and download the pushed media in accordance with an embodiment of the present invention.

For example, a first, most expensive option 803 may be “Express Delivery” which would deliver the pushed media to the friend in 18 minutes using queuing and cost $1.20, for example. The pushed media may be stored in a file in an MPEG 2 format that was recorded at a rate of 4 Mbps, for example. Queuing comprises buffering and delivering a previous part of the media and then buffering and delivering a next part of the media. For example, a first six minutes of the “Vacation in Alaska Video” may be buffered and delivered first, then a second six minutes may be buffered and delivered next, and so on until the entire media is delivered.

A second, less expensive option 802 may be “Normal Delivery” which would deliver the pushed media in 2 hours and 13 minutes without queuing and cost $0.59, for example. The pushed media may be stored in a file in an MPEG 2 format that was recorded at a rate of 1.5 Mbps, for example.

A third, least expensive option 804 may be “Overnight Delivery” which would deliver the pushed media by the next morning and cost only $0.05, for example. The pushed media may be stored in a file in an MPEG 2 format that was recorded at a rate of 19 Mbps and stored on a server, for example.

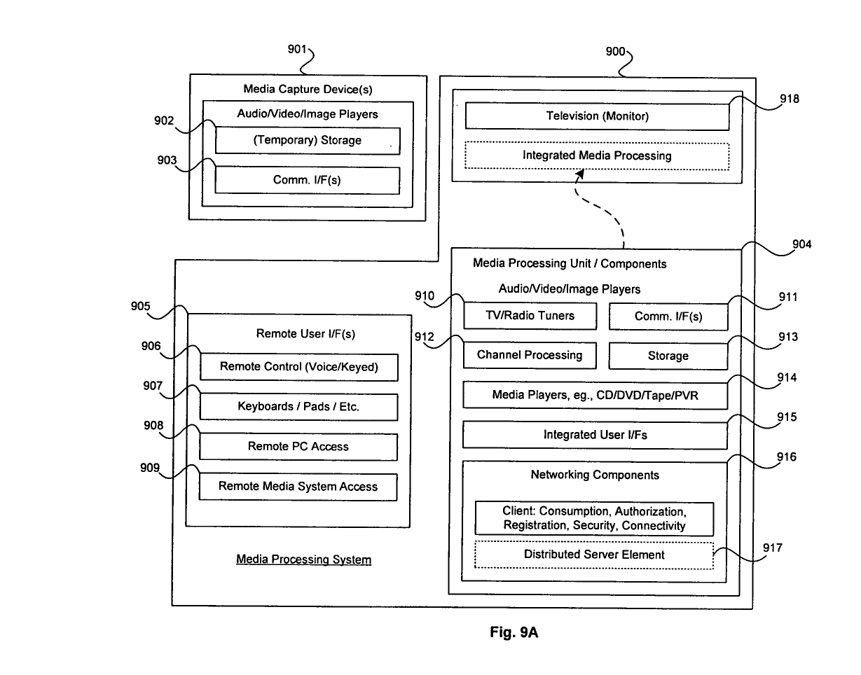

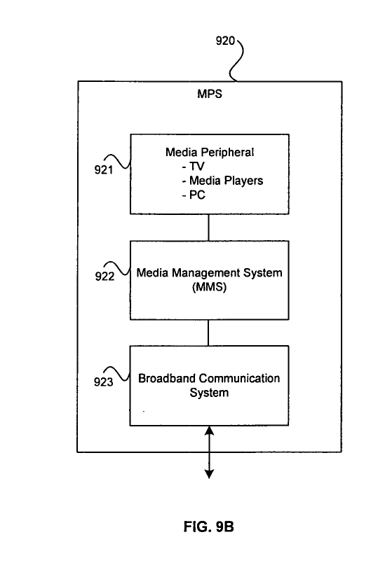

FIG. 9A illustrates the detailed elements of a media processing system (MPS) 900 and media capture devices 901 in accordance with an embodiment of the present invention. The media capture devices 901 may comprise audio, video, and image players, such as digital cameras, digital camcorders, and MP3 players, that each include a temporary storage area 902 and a communication interface 903 such as, for example, a USB interface or a wireless interface. The media capture devices 901 have the capability to interface to an MPS and a PC.

The MPS 900 comprises a media processing unit (MPU) 904, remote user interface(s) 905, and a TV screen 918 to provide integrated media processing capability and indirect user interface capability. The remote user interfaces 905 may comprise a voice or keyed remote control 906, keyboards and pads 907, a remote PC access interface 908, and a remote media system access interface 909 (i.e., providing access from another MPS).

The media processing unit (MPU) 904 comprises TV and radio tuners 910 for image and audio consumption, communications interfaces 911, channel processing 912 (creating, storing, indexing, viewing), storage 913, media players 914 (CD, DVD, Tape, PVR, MP3), an integrated user interface 915 (to provide a TV channel guide look-and-feel), networking components 916 to provide client functions such as consumption (billing), authorization (e.g., using digital certificates and digital ID's), registration, security, and connectivity. In an alternative embodiment of the present invention, the networking components 916 may include a distributed server element 917 that is part of a distributed server.

FIG. 9B illustrates an alternative embodiment of a media processing system (MPS) 920 in accordance with various aspects of the present invention. The MPS 920 is essentially an enhanced set-top-box for viewing and interacting with various user interfaces, media, data, and services that are available on the media exchange network using, for example, a remote control. The MPS 920 comprises a media peripheral 921, a MMS (media management system) 922, and a broadband communication interface 923.

The media peripheral 921 may include a TV (television), a PC (personal computer), and media players (e.g., a CD player, a DVD player, a tape player, and a MP3 player) for video, image, and audio consumption of broadcast and/or personal channels. The broadband communication interface 923 may include internal modems (e.g., a cable modem or DSL modem) or other interface devices in order to communicate with, for example, a cable or satellite headend.

The MMS 922 includes a software platform to provide functionality including media “push” capability, media “access” capability, media channel construction/selection, image sequence selection, text and voice overlay, channel and program naming, inter-home routing selection, authorship and media rights management, shared inter-home media experience, billing service, and a media guide user interface providing an integrated TV channel guide look-and-feel.

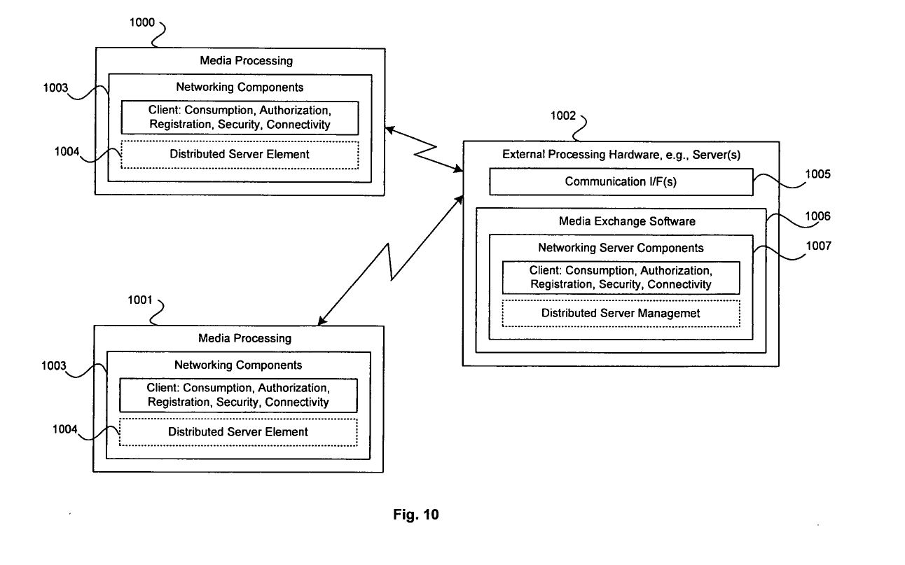

FIG. 10 illustrates connectivity between a PC 1000, an MPS 1001, and external processing hardware 1002 (e.g., a server) in accordance with an embodiment of the present invention. The PC 1000 and MPS 1001 include networking components 1003 to provide client functions such as consumption (billing), authorization, registration, security, and connectivity. Alternatively, the PC 1000 and MPS 1001 may include a distributed server element 1004 that is part of a distributed server.

The PC 1000 and MPS 1001 connect to the external processing hardware 1002 via wired or wireless connections. The external processing hardware 1002 comprises a distributed server or peer-to-peer server. The external processing hardware 1002 also comprises communication interfaces 1005 (e.g., cable interfaces, optical interfaces, etc.) and a media exchange software (MES) platform 1006. The MES platform 1006 in the external processing hardware 1002 allows for communication with the PC 1000 and MPS 1001 which may also use the same MES platform 1006. The external processing hardware 1002 also includes networking server components 1007 to provide the similar client functions such as consumption (billing), authorization, registration, security, and connectivity at the server side.

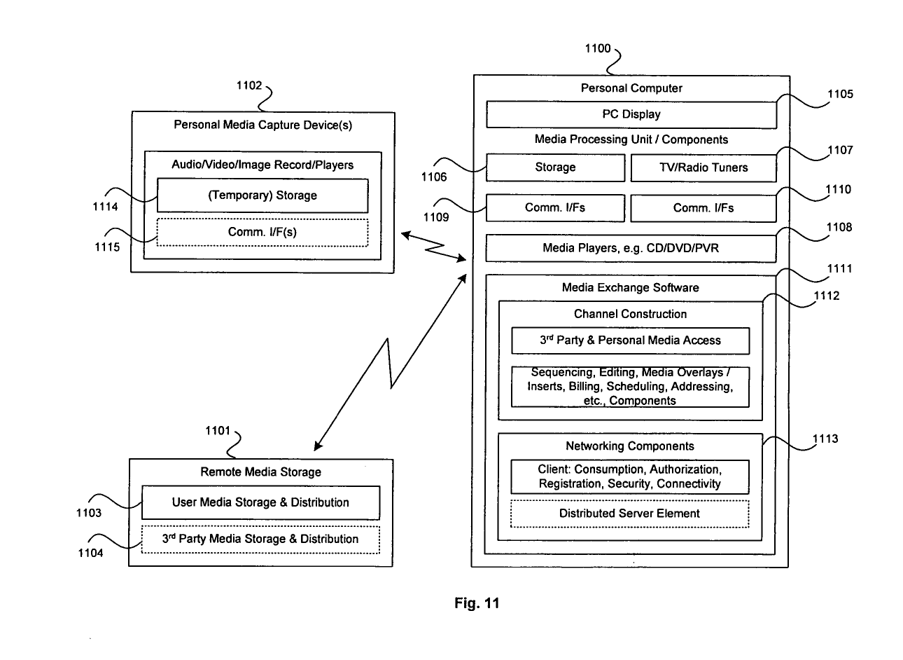

FIG. 11 illustrates connectivity between a PC 1100, remote media storage 1101, and personal media capture devices 1102 when the PC 1100 is used as the primary distributor of digital media such as in the case of PC-to-PC operation, in accordance with an embodiment of the present invention. The personal media capture devices 1102 and remote media storage 1101 connect to the PC 1100 via a wireless or wired connection. The remote media storage 1101 provides user media storage and distribution 1103 as well as third party media storage and distribution 1104. The personal media capture devices 1102 provide temporary storage 1114 and communication interfaces 1115.

Viewing is done using a PC monitor 1105 instead of a television screen. The PC 1100 may include storage 1106, TV/radio tuners 1107 for media consumption, media players 1108, and communication interfaces 1109 and user interfaces 1110 similar to those for the MPS of FIG. 9A. The PC 1100 includes a media exchange software (MES) platform 1111 that provides channel construction capability 1112 and networking capability 1113. The channel construction capability 1112 allows third party and personal media access, sequencing, editing, media overlays and inserts, billing, scheduling, and addressing.

In light of foregoing, certain aspects of the invention may be found in a method and system for providing media in a communication network. Certain embodiments of the method for providing media in a communication network may comprise locating media stored locally at least at a first location 103 in the communication network 100 and organizing the located media into channels. Accordingly, at least a portion of the organized channels may be transparently transferred to at least a second location 110 within the communication network. Certain embodiments of the system may comprise at least one processor that may be configured to locate media stored locally at least at a first location 103, such as a home or office, in the communication network and organizing the located media into channels. Accordingly, at least a portion of the organized channels may be transparently transferred by the processor to at least a second location 110 within the communication network 100. The second location 110 may also be a home or office. The processor may be a media processing system processor, a media management system processor, a computer processor, a media exchange software processor and a media peripheral processor.

Accordingly, the present invention may be realized in hardware, software, or a combination of hardware and software. The present invention may be realized in a centralized fashion in one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for providing media in a communication network, the method comprising:
locating media stored locally at least at a first location in the communication network;
organizing said located media into channels; and
transparently transferring at least a portion of said organized channels to at least a second location within the communication network.

2. The method according to claim 1, further comprising displaying said organized channels in at least one constructed display.

3. The method according to claim 2, wherein said constructed display is at least one of a media guide, device guide and a channel guide.

4. The method according to claim 2, wherein said constructed display is formatted as a graphical user interface.

5. The method according to claim 2, wherein said constructed display is displayed at least at one of said first location and said second location.

6. The method according to claim 5, further comprising presenting representations of locally stored media at said second location and representations of said transparently transferred media in a single constructed display.

7. The method according to claim 6, further comprising integrating representations of broadcast media in said presented single constructed display.

8. The method according to claim 1, further comprising transparently transferring media corresponding to at least a selected portion of said organized channels to said at least said second location.

9. The method according to claim 1, further comprising updating an existing constructed display at said second location to reflect said transparently transferred at least a portion of said organized channels.

10. The method according to claim 1, further comprising authorizing said transparent transfer of said at least a portion of said organized channels to at least said second location.

11. A machine-readable storage having stored thereon, a computer program having at least one code section for providing media in a communication network, the at least one code section being executable by a machine for causing the machine to perform steps comprising:
locating media stored locally at least at a first location in the communication network;
organizing said located media into channels; and
transparently transferring at least a portion of said organized channels to at least a second location within the communication network.

12. The machine-readable storage according to claim 11, further comprising code that causes said organized channels to be displayed in at least one constructed display.

13. The machine-readable storage according to claim 12, wherein said constructed display is at least one of a media guide, device guide and a channel guide.

14. The machine-readable storage according to claim 12, wherein said constructed display is formatted as a graphical user interface.

15. The machine-readable storage according to claim 12, wherein said constructed display is displayed at least at said first location and said second location.

16. The machine-readable storage according to claim 15, further comprising code for presenting representations of locally stored media at said second location and representations of said transparently transferred media in a single constructed display.

17. The machine-readable storage according to claim 16, further comprising code for integrating representations of broadcast media in said presented single constructed display.

18. The machine-readable storage according to claim 11, further comprising code for transparently transferring media corresponding to at least a selected portion of said organized channels to said at least said second location.

19. The machine-readable storage according to claim 11, further comprising code for updating an existing constructed display at said second location to reflect said transparently transferred at least a portion of said organized channels.

20. The machine-readable storage according to claim 11, further comprising code for authorizing said transparent transfer of said at least a portion of said organized channels to at least said second location.

21. A system for providing media in a communication network, the system comprising:
at least one processor that locates media stored locally at least at a first location in the communication network;
said at least one processor organizes said located media into channels; and
said at least one processor transparently transfers at least a portion of said organized channels to at least a second location within the communication network.

22. The system according to claim 21, wherein said at least one processor caused said organized channels to be displayed in at least one constructed display.

23. The system according to claim 22, wherein said constructed display is at least one of a media guide, device guide and a channel guide.

24. The system according to claim 22, wherein said constructed display is formatted as a graphical user interface.

25. The system according to claim 22, wherein said constructed display is displayed at least at said first location and said second location.

26. The system according to claim 25, wherein said at least one processor presents representations of locally stored media at said second location and representations of said transparently transferred media in a single constructed display.

27. The system according to claim 26, further comprising integrating representations of broadcast media in said presented single constructed display.

28. The system according to claim 21, wherein said at least one processor transparently transfers media corresponding to at least a selected portion of said organized channels to said at least said second location.

29. The system according to claim 21, wherein said at least one processor updates an existing constructed display at said second location to reflect said transparently transferred at least a portion of said organized channels.

30. The system according to claim 21, wherein said at least one processor receives authorization for said transparent transfer of said at least a portion of said organized channels to at least said second location.

31. The system according to claim 21, wherein said at least one processor is at least one of a media processing system processor, a media management system processor, a computer processor, a media exchange software processor and a media peripheral processor.
